(19) United States
(12) Patent Application Publication
(10) Pub. No.: US 2015/0322210 A1
(43) Pub. Date: Nov. 12, 2015

(54) Polyaryl Ether Polymers End-Capped with Phenolic Amino Acids

(71) Applicant: SOLVAY SPECIALTY POLYMERS USA, LLC, Alpharetta, GA (US)

(72) Inventors: Suresh R. SRIRAM, AURORA, IL (US); Narmandakh TAYLOR, Cumming, GA (US)

(73) Assignee: SOLVAY SPECIALTY POLYMERS USA, LLC, Alpharetta, GA (US)

(21) Appl. No.: 14/652,547

(22) PCT Filed: Dec. 17, 2013
(86) PCT No.: PCT/EP2013/076813

§ 371 Date: Jun. 16, 2015

Related U.S. Application Data
(60) Provisional application No. 61/738,234, filed on Dec. 17, 2012.

(51) Int. Cl. C08G 75/23; C08J 9/00; C08G 65/34

(52) U.S. Cl. CPC C08G 75/23; C08G 65/34; C08J 9/00; C08J 2371/08; C08J 2381/06

(57) ABSTRACT

The invention relates to modified polyaryl ether polymers (PAEs) obtained by end-capping the polymers with a phenolic aminoacid, in particular with a bio-phenolic aminoacid such as L-tyrosine. The polymers of the present invention feature high thermal resistance and increased hydrophilicity. The present invention also relates to a method for the manufacture of those polymers, and their use in the manufacture of shaped articles including membranes.

This application claims priority to U.S. provisional application No. 61/738,234 filed Dec. 17, 2012, the whole content of this application being incorporated herein by reference for all purposes.

### TECHNICAL FIELD

The present invention relates to modified polyaryl ether polymers (PAEs) having increased hydrophilicity, a method for their manufacture, and their use in the manufacture of membranes.

### BACKGROUND ART

Polyaryl ether polymers (PAEs) like polyaryl ether sulfones (PES) are widely used as filtration membranes in water-based applications due to their good thermal, mechanical, and chemical stability. Membranes are prepared from these polymers mostly by solvent phase-inversion methods to give sheets or fibers with porous structures suitable for various separation processes. These membranes, however, are relatively hydrophobic which, in the presence of proteins, leads to irreversible fouling of the membrane and reduced filtration performance. It is therefore desirable to provide more hydrophilic polyaryl ether polymers for these membrane applications. Membranes that are too hydrophilic, however, swell significantly in water resulting in greatly reduced mechanical strength.

There have been many reported attempts to increase the hydrophilicity of polyethersulfone membranes. [See: B. Van der Bruggen, “Chemical Modification of Polyethersulfone Nanofiltration Mebranes: A Review, J. Appl Polym. Sci., 114, 630-642 (2009), and references therein]. One common method involves sulfonation of the polymer using sulphuric acid; however, this process is difficult to control and gives inconsistent results while generating significant waste streams. Electron beam and plasma treatments have also been reported which have also given inconsistent results. Changes in the structure of the polymer backbone can also increase hydrophilicity although these efforts often involve the use of expensive petroleum-based comonomers that can compromise thermal or mechanical properties of the formed membrane. Blends of more hydrophilic polymers or other additives with polyether sulfones have also been described, but leaching of the additives can occur from the membrane while in use during water filtration operations leading to reduced separation efficiency.

U.S. Pat. No. 5,567,795 and U.S. Pat. No. 5,710,282 disclose a process for the preparation of highly branched macromolecule polymers comprising the reaction of a multifunctional phenolic “branching monomer” with a second “end-capping monomer” derived in part from compounds such as L-tryptophan methyl ester hydrochloride. They also teach that such highly branched macromonomer polymers can be copolymerized with polysulfones and polycarbonates. Neither of the above documents discloses the preparation of polyether sulfones or polyether ketones end-capped with phenolic amino-acids nor demonstrates the usefulness of these hyperbranched polymers to make materials suitable for use in membrane applications.

S [symbol] AWIŃSKA, Danuta, et al. SPECTROSCOPIC STUDIES ON UVC-INDUCED PHOTODEGRADATION OF HUMIC ACIDS. Electronic Journal of Polish Agricultural Universities. 2001, vol. 5, no. 2. discloses the oxidative polymerization/condensation of tyrosine with hydroquinone; however, there is no mention of potential use of these polymers in membrane applications.

All of the approaches described so far to increase the hydrophilicity of polyaryl ethers for membrane applications involve extra complex and costly steps and often give inconsistent membrane surface characteristics. A simple modification of polyaryl ethers (PAEs) using readily available bio-sourced materials is desired that gives increased hydrophilicity while maintaining the good thermal and mechanical properties of unmodified PAEs.

### DISCLOSURE OF THE INVENTION

The Applicant has now found that the hydrophilicity of polyaryl ether polymers (PAEs) can be significantly increased while maintaining high thermal resistance by end-capping the polymers with a phenolic aminoacid, in particular with a bio-sourced (otherwise referred to as naturally occurring) phenolic aminoacid.

In particular, the polyaryl ether polymers (p-PAEs) of the invention are polyaryl ether ketones (p-PAEKs) or polyaryl ether sulfones (p-PES) or polyaryl ether ketones-polyaryl ether sulfones (p-PAEKs-PES) comprising recurring units derived from the polycondensation of at least one dihalo compound [dihalo (AA)] having the formula here below:

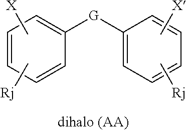

wherein:
G is a group of formula —C(O)— or a group of formula —SO₂—
X and X′, equal to or different from one another, are halogen;
each of R, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j is zero or is an integer from 1 to 4
   with at least one aliphatic, cyloaliphatic or aromatic diol HO—R_{diol}—OH in the presence of a phenolic aminoacid.

As explained in greater detail in the following description, one or more dihalo (AA) compounds and one or more HO—R^{o}_{diol}-OH diols can be used in the polycondensation reaction; in other words, the dihalo (AA) compound and the HO—R^{o}_{dial}-OH can be each equal to or different from one another. For example, only dihalo diketo compounds [dihalo (AAₖ)] or only dihalo disulfo compounds [dihalo (AAₛ)] or both dihalo (AAₖ) and dihalo (AAₛ) can be used.

Accordingly, the polyaryl ether polymers (p-PAEs) of the invention comprise recurring units of formula (Rₐ) below:

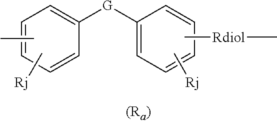

wherein:
G is a group of formula —C(O)— or a group of formula —SO₂—;
each of R, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j is zero or is an integer from 1 to 4;
R_{diol} is a group of formula —O—R^{o}_{diol}-O— wherein R^{o}_{diol} is independently selected from the following classes:
   (a) a straight or branched hydrocarbon chain containing from 2 to 20 carbon atoms, optionally substituted with one or more hydroxyl groups and optionally interrupted by one or more heteroatoms independently selected from N, O and S;
   (b) a C₃-C₁₂ cycloalkyl or a C₆-C₁₂ bicycloalkyl group, each optionally containing one or more heteroatoms independently selected from N, O and S and optionally substituted with one or more C₁-C₄ straight or branched alkyl groups and
   (c) an aryl group of formula —Ar¹-(T-Ar²)ₙ—, wherein:
Ar¹ and Are, equal to or different from one another at each occurrence, are independently a aromatic mono or polynuclear group and
T is selected from the group consisting of: a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

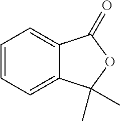

and n is 0 or an integer of 1 to 5
said polymer (p-PAE) comprising at least two chain ends, wherein at least one chain end is a unit of formula (Rₐₘᵢₙₒ) below:

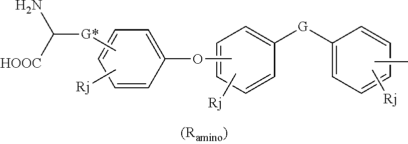

wherein G, R and j are as defined above and G* is a straight or branched divalent alkylene group.

According to a preferred embodiment, the p-PAEs of the invention comprise two chain ends; more preferably, at least one chain end comprises an (Rₐₘᵢₙₒ) unit in which G* is —CH₂—. Even more preferably, at least one chain end comprises an (Rₐₘᵢₙₒ) unit in which G* is —CH₂— and j is 0. Still more preferably, at least one chain end comprises an (Rₐₘᵢₙₒ₁) unit of formula:

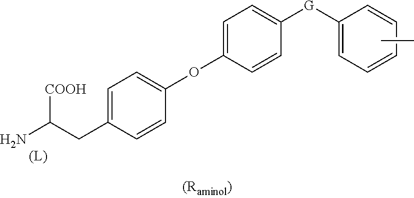

Polymers according to this embodiment can be obtained by end-capping with L-tyrosine.

According to a further preferred embodiment, polymers (p-PAEs) of the invention comprise at least one recurring unit comprising an R_{diol} group in which R^{o}_{diol} belongs to class b) as defined above which is a 1,4:3,6-dianhydrohexitol sugar diol residue, in particular an isosorbide, isomannide or isoiodide residue. In such polymers, —O—R^{o}_{diol}-O— is thus selected from the group of formulae (I)-(III) below:

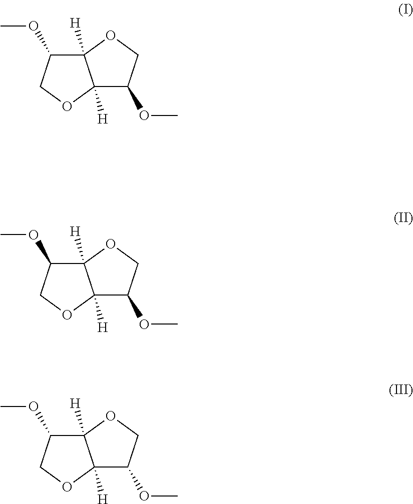

According to a more preferred embodiment, the polymers (p-PAEs) of the invention are (p-PAEs) wherein all recurring units (Rₐ) comprise an —O—R^{o}_{diol}—O— group selected from the group of formulae (I) to (III) above. More preferably, —O—R^{o}_{diol}-O— is an isosorbide residue, i.e. a group of formula (I).

According to a further preferred embodiment, the polymers (p-PAEs) of the invention are polyaryl ether ketones (p-PAEKs) which derive from the polycondensation of a dihaloketo compound [dihalo (AAₖ)] of formula:

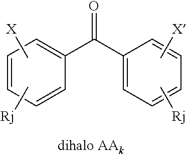

wherein X, X′, R and j are as defined above
with one or more diols HO—R^{o}_{diol}-OH as defined above in the presence of a phenolic aminoacid.

A first preferred group of polymers (p-PAEKs) is that in which at least one recurring unit (Rₐ) is a recurring unit in which —O—R^{o}_{diol}-O— is selected from the group of formulae (I) to (III) above; among this group, a preferred one is that in which in all recurring units (Rₐ)—O—R^{o}_{diol}-O— is selected from the group of formulae (I) to (III) above. Typically —O—R^{o}_{diol}-O— is an isosorbide residue, i.e. a group of formula (I) as defined above. Polymers (p-PAEKs) belonging to this first preferred group are usually obtained by polycondensation of a dihaloketo compound dihalo (AAₖ) as defined above with a diol HO—R^{o}_{diol}-OH [diol (b1)] in which —O—R^{o}_{diol}-O— is selected from the group of formulae (I) to (III) as defined above and, optionally, one or more diols HO—R^{o}_{diol}-OH in which R^{o} belongs to classes (a) and (c) as defined above, in the presence of a phenolic aminoacid.

A second preferred group of polymers (p-PAEKs) is that in which at least one recurring unit (Rₐ) is a recurring unit in which R^{o}_{diol} is an aryl group of formula —Ar¹-(T-Ar²)ₙ— wherein Ar¹, T, Ar² and n are as defined above. These polymers (p-PAEKs) can be obtained by polycondesation of a dihaloketo compound dihalo (AAₖ) with an aromatic diol HO—R^{o}_{diol}-OH (c1) wherein R^{o}_{diol}-Ar¹-(T-Ar²)ₙ—, wherein Ar¹, T, Ar² and n are as defined above, and, optionally, one or more diols HO—R^{o}_{diol}-OH in which R^{o} belongs to classes (a) and (b) as defined above, in the presence of a phenolic aminoacid.

A preferred example of polymers (p-PAEKs) belonging to this second group includes (p-PAEKs) in which all recurring units (Rₐ) are recurring units in which R^{o}_{diol} is —Ar¹-(T-Ar²)ₙ—, wherein Ar¹, T, Ar² and n are as defined above.

In the preparation of the (p-PAEKs) of the invention, further dihaloketo compounds (A′A′ₖ) different from dihalo (AAₖ) can also be used; thus, in addition to recurring units Rₐ, polymers (p-PAEKs) of the invention may further comprise at least one recurring unit)(Ra^{o}) comprising an Ar—(CO)—Ar group, with Ar and Ar′, equal to or different from each other, being aromatic groups. Recurring units (R^{o}ₐ) are generally selected from the group of formulae (J-A)-(J-O) herein below:

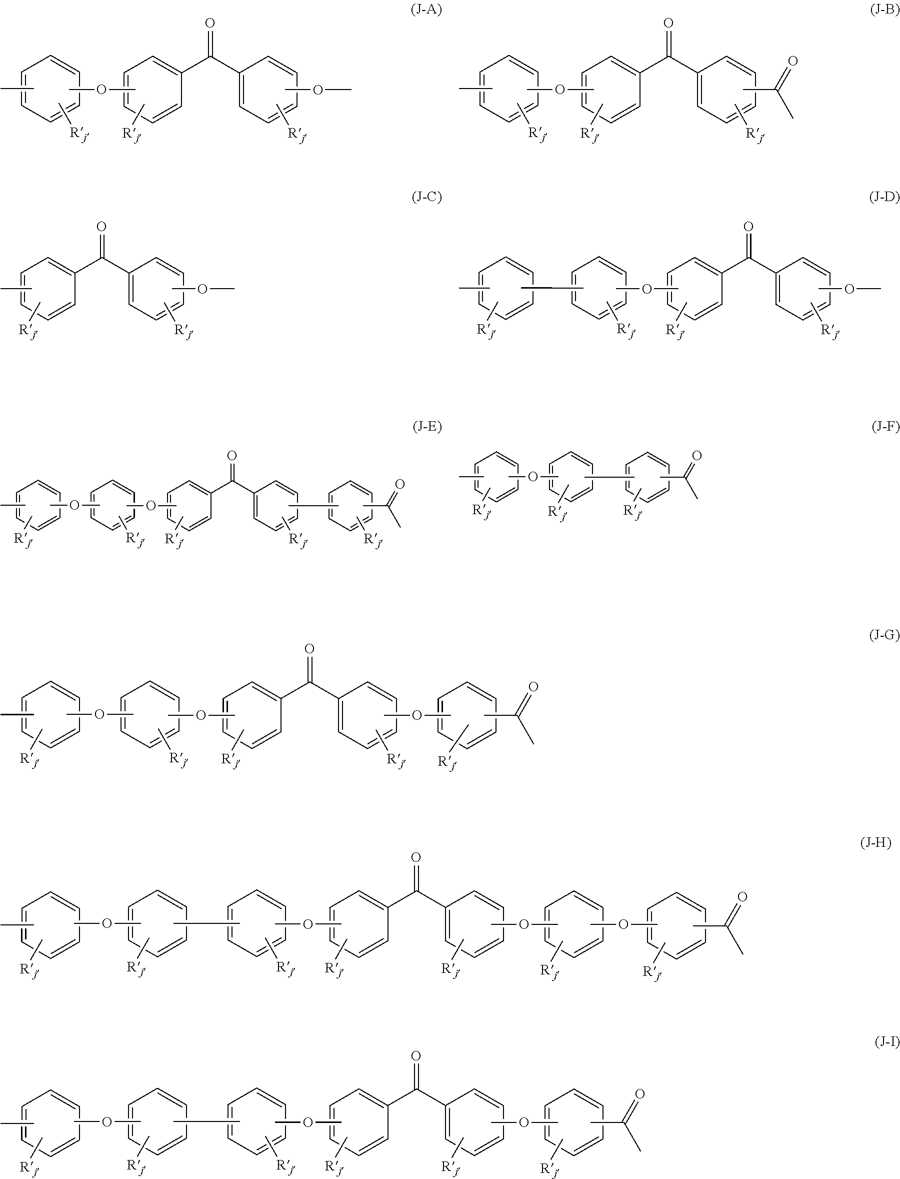

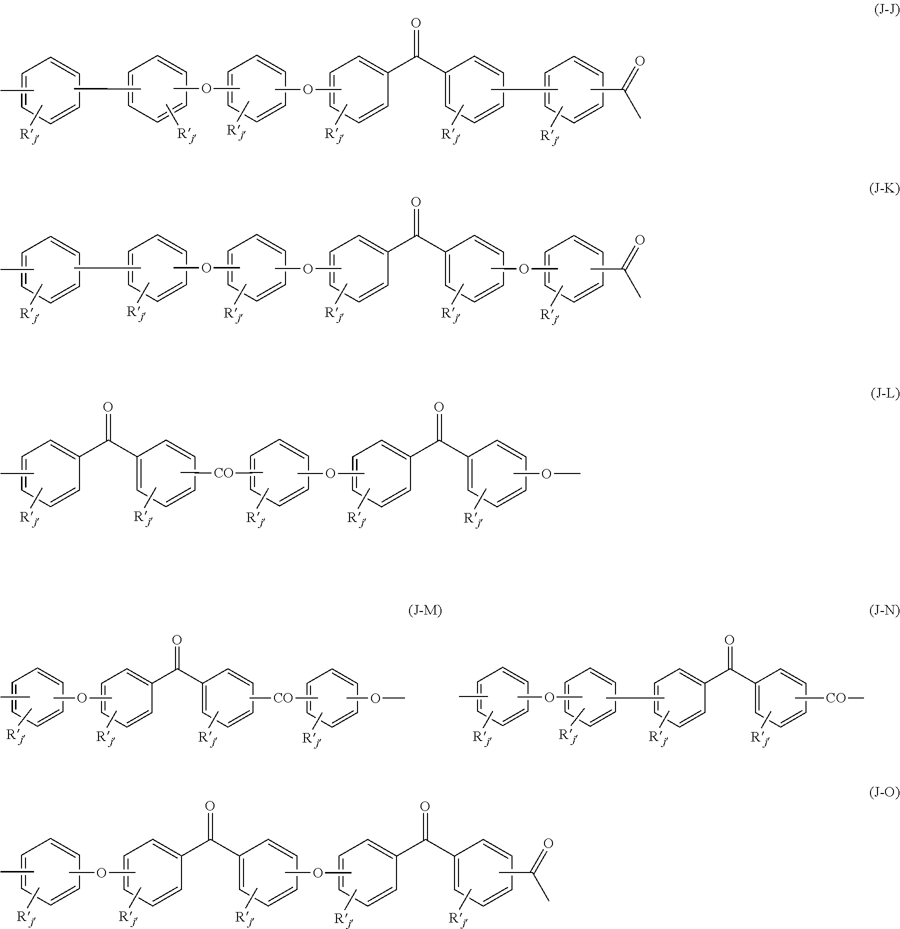

each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4.

In recurring units (R^{o}ₐ), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkages.

Still, in recurring units (R^{o}ₐ), j′ is at each occurrence zero, that is to say that the phenylene moieties have no other substituents than those enabling linkage in the main chain of the polymer.

Preferred recurring units (R^{o}ₐ) are thus selected from those of formulae (J′-A) to (J′-O) herein below:

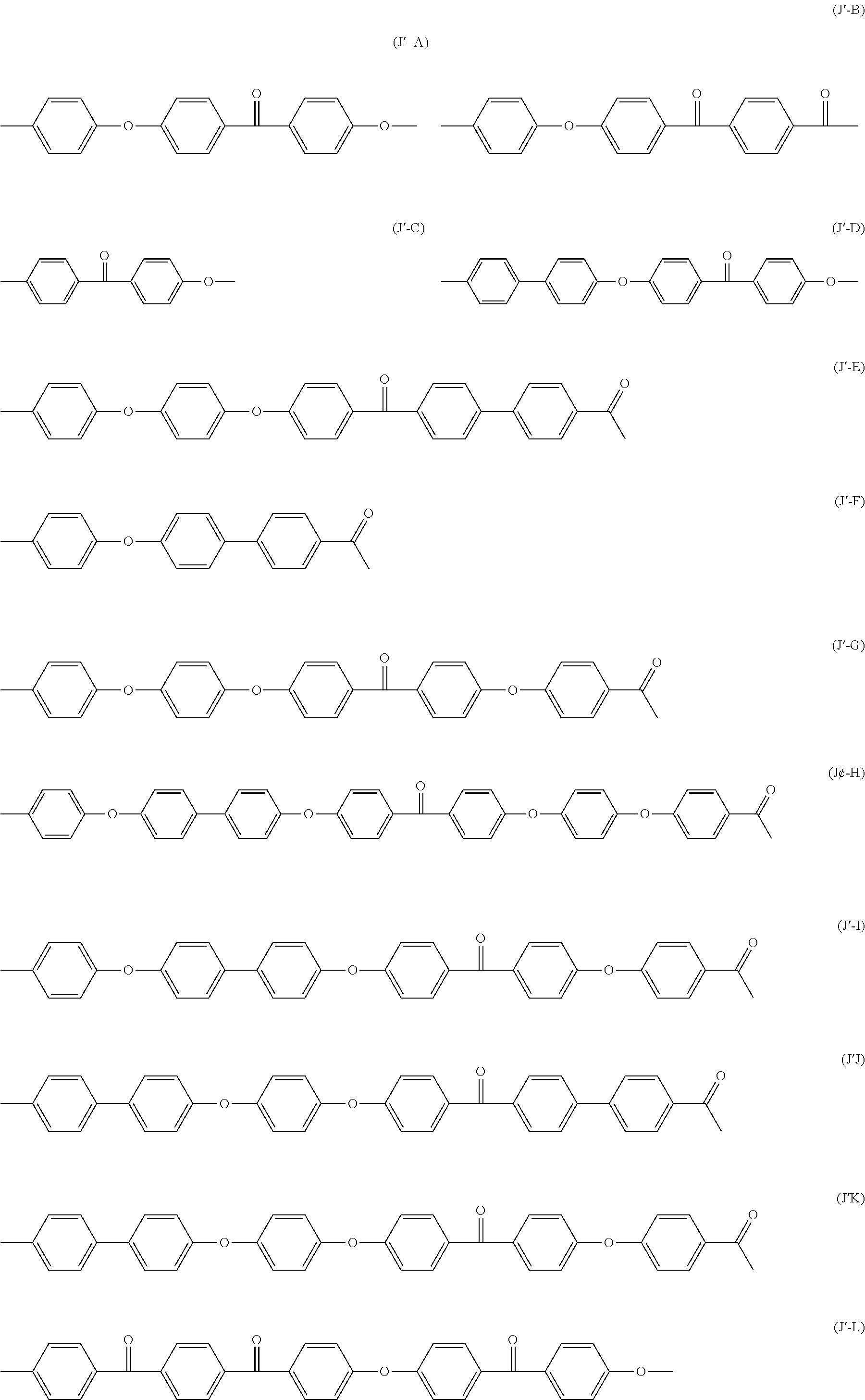

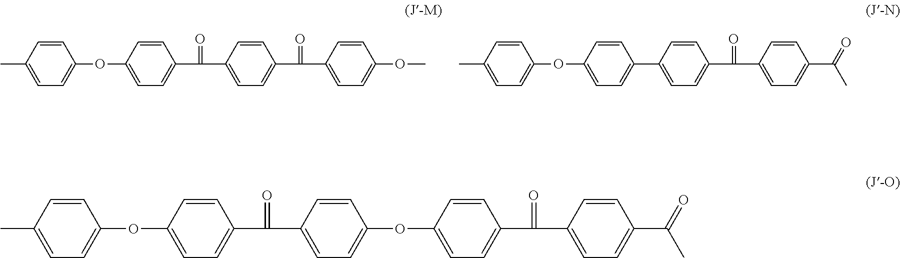

In a still further embodiment, polymers (p-PAEs) of the invention are polyaryl ether sulfones (p-PES) which derive from the polycondensation of at least one dihalosulfone [dihalo (AAₛ)] of formula:

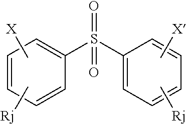

wherein X, X′, R and j are as defined above
with one or more diols HO—R^{o}_{diol}-OH as defined above in the presence of a phenolic aminoacid.

A first preferred group of polymers (p-PES) is that in which at least one recurring unit (Rₐ) is a recurring unit in which —O—R^{o}_{diol}-O— is selected from the group of formulae (I) to (III) above; among this group, a preferred one is that in which in all recurring units (Rₐ)—O—R^{o}_{diol}-O— is selected from the group of formulae (I) to (III) above. Typically —O—R^{o}_{diol}-O— is an isosorbide residue, i.e. a group of formula (I) as defined above. Polymers (p-PES) belonging to this first preferred group are usually obtained by polycondensation of at least one dihalo (AAₛ) as defined above with at least one diol HO—R^{o}_{diol}-OH (b1) in which —O—R^{o}_{diol}-O— is selected from the group of formulae (I) to (III) and, optionally, one or more diols HO—R^{o}—OH (a1) and (c1) in which R^{o} belongs to classes (a) and (c) as defined above, in the presence of a phenolic aminoacid.

A second preferred group of polymers (p-PES) is that in which at least one recurring unit (Rₐ) is a recurring unit in which R^{o}_{dial} is an aryl group of formula —Ar¹-(T-Ar²)ₙ— wherein Ar¹, T, Ar² and n are as defined above. Polymers (p-PES) belonging to this second preferred group are usually obtained by polycondensation of a dihalo (AAₛ) with one or more diols HO—R^{o}_{diol}-OH (c1) in which R^{o}_{diol} is —Ar¹-(T-Ar²)ₙ—, wherein Ar¹, T, Ar² and n are as defined above, in the presence of a phenolic aminoacid. A preferred example of polymers (p-PES) belonging to this second group includes polymers (p-PES) in which all recurring units (Rₐ) are recurring units in which R^{o}_{diol} is —Ar¹-(T-Ar²)ₙ—, wherein Ar¹, T, Ar² and n are as defined above.

Polymers (p-PES) according to the invention may also comprise, in addition to recurring units Rₐ derived from a dihalo (AAₛ) as defined above, as defined above, recurring units (R*ₐ) deriving from a dihalo (A′A′s) different from dihalo (AAₛ), said dihalo (A′A′s) comprising a Ar—SO₂—Ar′ group, with Ar and Ar′, equal to or different from one another, being aromatic groups.

Examples of recurring units R*ₐ are those having formulae (S-A) to (S-D) here below:

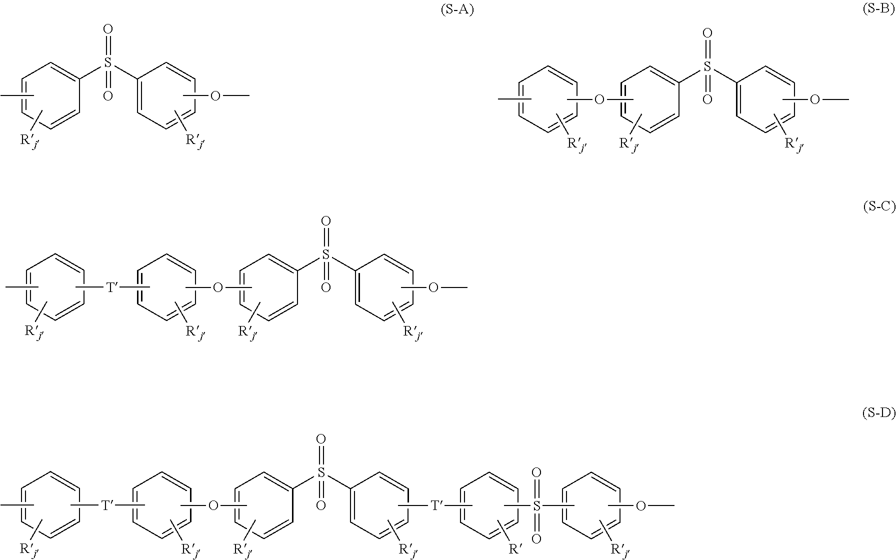

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4;
T and T′ are as defined above.

A further object of the present invention is a process for the preparation of the polyaryl ether polymers (p-PAEs) as defined above.

The process of the invention advantageously comprises reacting in a solvent mixture comprising a polar aprotic solvent:
at least one dihalo compound dihalo (AA):

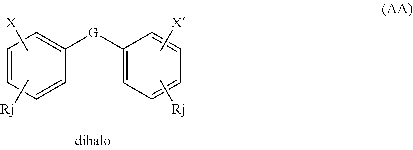

wherein G, X, X′, R and j are as defined above and
at least one diol HO—R^{o}diol-OH as defined above;
a phenolic aminoacid of formula:

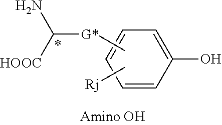

wherein G*, R and j are as defined above
and an alkali metal carbonate.

When the process is intended to manufacture polymers (p-PAEs) comprising at least one recurring unit (R^{o}ₐ) and/or at least one recurring unit (R*ₐ), the process may comprise additionally reacting in said solvent mixture at least one dihalo (A′A′) (including dihalo (A′A′k) and dihalo (A′A′ₛ)) different from dihalo (AA).

The at least one diol HO—R^{o}diol-OH is used in an amount ranging from about 50 to about 150% mol with respect to dihalo (AA) or with respect to dihalo (AA)+dihalo (A′A′), while the phenolic aminoacid is used in a molar amount ranging from about 0.02 to about 5% mol with respect to dihalo (AA) or dihalo (A′A′).

Preferred dihalo compounds dihalo (AAₖ) are 4,4′-difluorobenzophenone, 4,4′-dichlorobenzophenone and 4-chloro-4′-fluorobenzophenone, with 4,4′-difluorobenzophenone being particularly preferred.

Preferred dihalo (AAₛ) are 4,4′-difluorodiphenyl sulfone, dichlorodiphenyl sulfone, 4-chloro-4′-fluorodiphenyl sulfone, with 4,4′-difluorodiphenyl sulfone being particularly preferred.

Among compounds dihalo (A′A′ₛ) different from dihalo (AAₛ) mention can be notably made of compounds of formula (S) here below:

(S) X-Ara-SO₂-[Ar⁴-(T-Ar²)ₙ—SO₂]ₘ—Ar⁵—X

wherein:
n and m, equal to or different from each other, are independently zero or an integer of 1 to 5;
X is an halogen selected from F, Cl, Br, I;
each of Ar², Ar³, Ar⁴, Ar⁵ equal to or different from each other and at each occurrence, is an aromatic moiety of the formula:

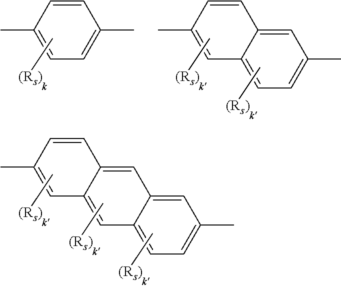

wherein:
each Rₛ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
k is zero or an integer of 1 to 4; k′ is zero or an integer of 1 to 3;
T is a bond or a divalent group optionally comprising one or more than one heteroatom; preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

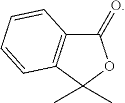

Examples of dihalo (A′A′ₛ) different from dihalo (AAₛ) suitable for being used in the process of the present invention, mention can be made in particular of the following molecules:

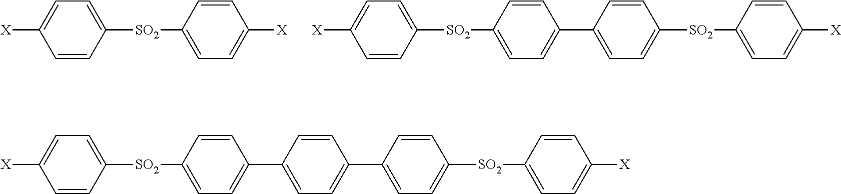

wherein X is as defined above.

As far as diols HO—R^{o}_{diol}-OH are concerned, a first preferred group is group (b1), in which —O—R^{o}_{diol}-O— is selected from the group of formulae (I) to (III) as defined above; a preferred diol in this group is isosorbide. A second preferred group is group (c1), having formula:

HO—Ar¹-(T′-Ar²)ₙ—OH formula (c1)

wherein:
n is zero or an integer of 1 to 5;
each of Ar¹ and Ar², equal to or different from each other and at each occurrence, is an aromatic moiety of the formula:

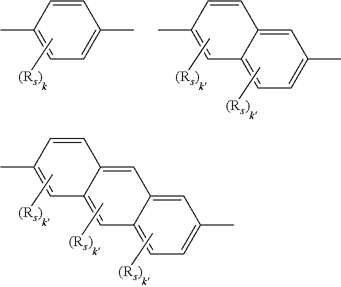

wherein:
each Rₛ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
k is zero or an integer of 1 to 4; k′ is zero or an integer of 1 to 3;
T′ is a bond or a divalent group optionally comprising one or more than one heteroatom; preferably T is selected from the group consisting of a bond, —SO₂—, —CH₂—, —C(O)—, —C(CH₃)₂—, —C(CF₃)₂—, —C(═CCl₂)—, —C(CH₃)(CH₂CH₂COOH)—, and a group of formula:

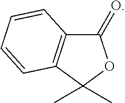

Particularly preferred diols of group (c1) are those having the formulae reported herein below.

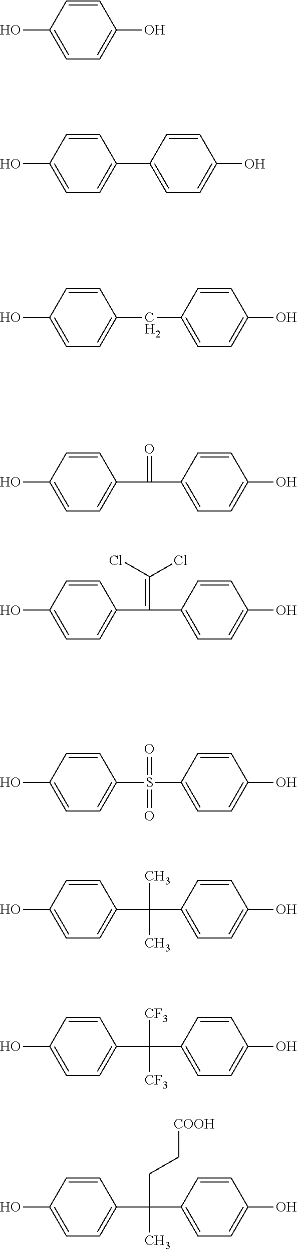

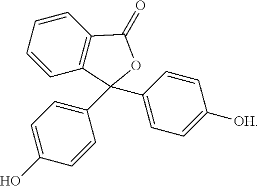 [SMILES: O=C1OC(c2ccc(O)cc2)(c2ccc(O)cc2)c2ccccc21]

As far as the phenolic aminoacid is concerned, preferred are those wherein G* is —CH₂—; more preferably, the aminoacid is L-tyrosine, as it is a naturally occurring aminoacid, which is solid and therefore easy to add in to the polymerization reaction.

The alkali metal carbonate is preferably sodium carbonate, potassium carbonate, rubidium carbonate and cesium carbonate. Sodium carbonate and especially potassium carbonate are preferred. Mixtures of more than one carbonates can be used, for example, a mixture of sodium carbonate or bicarbonate and a second alkali metal carbonate or bicarbonate having a higher atomic number than that of sodium.

The amount of said alkali metal carbonate used, when expressed by the ratio of the equivalents of alkali metal (M) per equivalent of hydroxyl group (OH) [eq. (M)/eq. (OH)] ranges from about 1.0 to about 3.0, preferably from about 1.1 to about 2.5, and more preferably from about 1.5 to about 2.0.

The use of an alkali metal carbonate having an average particle size of less than about 100 μm, preferably of less than about 50 μm is particularly advantageous. The use of an alkali metal carbonate having such a particle size permits the synthesis of the polymers to be carried out at a relatively lower reaction temperature with faster reaction.

In the process of the invention, the one or more dihalo compound dihalo (AA) and, optionally, the one or more dihalo (A′A′), the one or more diol HO—R^{o}_{diol}-OH and the phenolic aminoacid are dissolved or dispersed in a solvent mixture comprising a polar aprotic solvent. If desired, an additional solvent can be used together with the polar aprotic solvent which forms an azeotrope with water, whereby water formed as a by-product during the polymerization may be removed by continuous azeotropic distillation throughout the polymerization.

The by-product water and carbon dioxide possibly formed during the polymerization can alternatively be removed using a controlled stream of an inter gas such as nitrogen or argon over the reaction mixture in addition to or in the absence of an azeotrope-forming solvent as described above.

For the purpose of the present invention, the term “additional solvent” is understood to denote a solvent different from the polar aprotic solvent and the reactants and the products of said reaction.

As polar aprotic solvents, sulphur containing solvents known and generically described in the art as dialkyl sulfoxides and dialkylsulfones wherein the alkyl groups may contain from 1 to 8 carbon atoms, including cyclic alkyliden analogs thereof, can be mentioned. Specifically, among the sulphur-containing solvents that may be suitable for the purposes of this invention are dimethylsulfoxide, dimethylsulfone, diphenylsulfone, diethylsulfoxide, diethylsulfone, diisopropylsulfone, tetrahydrothiophene-1,1-dioxide (commonly called tetramethylene sulfone or sulfolane) and tetrahydrothiophene-1-monoxide and mixtures thereof. Nitrogen-containing polar aprotic solvents, including dimethylacetamide, dimethylformamide and N-methyl pyrrolidone (i.e., NMP) and the like have been disclosed in the art for use in these processes, and may also be found useful in the practice of this invention.

The additional solvent that forms an azeotrope with water will generally be selected to be inert with respect to the monomer components and polar aprotic solvent. Suitable azeotrope-forming solvents for use in such polymerization processes include aromatic hydrocarbons such as benzene, toluene, xylene, ethylbenzene, chlorobenzene and the like.

The azeotrope-forming solvent and polar aprotic solvent are typically employed in a weight ratio of from about 1:10 to about 1:1, preferably from about 1:5 to about 1:3.

The polymer (p-PAE) of the present invention can notably be used for the manufacture of membranes, films and sheets, and three-dimensional moulded parts.

As per the processing, the polymer (p-PAE) can be advantageously processed for yielding all above mentioned articles by melt processing (including injection moulding, extrusion moulding, compression moulding), but also by solution processing, because of the solubility of the polymer (p-PAE).

Non limitative examples of shaped articles which can be manufactured from polymer (p-PAE) using different processing technologies are generally selected from the group consisting of melt processed films, solution processed films (porous and non porous films, including solution casted membranes, and membranes from solution spinning), melt process monofilaments and fibers, solution processed monofilaments, hollow fibers and solid fibers, and injection and compression molded objects.

Among membranes, the polymer (p-PAE) of the invention is particularly suitable for manufacturing membranes intended for contact with aqueous media, including body fluids; thus, shaped articles which can be manufactured from the polymer (p-PAE) as above detailed are advantageously membranes for bioprocessing and medical filtrations, including hemodialysis membranes, membranes for food and beverage processing, membranes for waste water treatment and membranes for industrial process separations involving aqueous media.

From an architectural perspective, membranes manufactured from the polymer (p-PAE) as above detailed may be provided under the form of flat structures (e.g. films or sheets), corrugated structures (such as corrugated sheets), tubular structures, or hollow fibers; as per the pore size is concerned, full range of membranes (non porous and porous, including for microfiltration, ultrafiltration, nanofiltration, and reverse osmosis) can be advantageously manufactured from the polymer (p-PAEs) of the invention; pore distribution can be isotropic or anisotropic.

Shaped articles manufactured from the polymer (p-PAE) can be, as above mentioned, under the form of films and sheets. These shaped articles are particularly useful as specialized optical films or sheets, and/or suitable for packaging.

Further, shaped articles manufactured from the polymer (p-PAE) of the invention can be three-dimensional moulded parts, in particular transparent or coloured parts.

Among fields of use wherein such injection moulded parts can be used, mention can be made of healthcare field, in particular medical and dental applications, wherein shaped articles made from the (p-PAE) of the invention can advantageously be used for replacing metal, glass and other traditional materials in single-use and reusable instruments and devices.

A further object of the invention are shaped articles manufactured from the polymer (p-PAE) as above detailed.

Should the disclosure of any patents, patent applications, and publications which are incorporated herein by reference conflict with the description of the present application to the extent that it may render a term unclear, the present description shall take precedence.

The invention is illustrated in greater detail in the following experimental section and non-limiting examples.

### EXPERIMENTAL SECTION

### Example 1

### Synthesis of a Polyaryl Ether Sulfone Polymer End-Capped with L-Tyrosine

A 500 mL four-neck round bottom flask, equipped with mechanical stirrer,

Dean-Stark trap, nitrogen inlet/outlet, and condenser, was charged with 29.284 g (0.117 moles) bisphenol S, 0.883 g (0.00488 moles) L-tyrosine, 35.000 g (0.122 moles DCDPS, 18.523 g (0.134 moles) K₂CO₃, and 132 g sulfolane. The reaction mixture was stirred and warmed to 210° C. over 30 minutes and maintained at that temperature for six hours. The viscous reaction mixture was cooled to 140° C. and 100 mL N-methylpyrrolidone (NMP) added to reduce the viscosity. The diluted reaction mixture was further cooled to room temperature and poured slowly in to a Waring blender while stirring containing 500 mL methanol and 10 mL 10% aqueous HCl to give a porous white powder. The polymer solid was isolated by filtration, washed three times with hot (70° C.) DI water and once with methanol, and finally dried in a vacuum oven at 90° C. for 16 hours. The glass transition temperature (Tg) was determined using DSC (20° C./min) and the result is shown in Table 1. A 20 wt % solution of the polymer in NMP was poured into an aluminium pan on a hot plate at 100° C. and left at that temperature for 10 hours. The film was removed from the pan and dried for 16 hours in a vacuum oven at 140° C. to completely remove residual NMP. The film was transparent, tough, and creasable with uniform thickness. A portion of the film was used to determine the water contact angle (ec) using a DataPhysics OCA 20 Static Contact Angle instrument and the result reported in Table 1. Another portion of the film was dried thoroughly in an oven and weighed (Dry weight), then soaked in water at room temperature (21° C.) for 24 hours. The film was removed from the water, briefly padded dry, and reweighed (Wet weight) to give wt % water absorbed=100*((Wet weight−Dry weight)/Dry weight) reported in Table 1.

### Example 2

### Synthesis of a Polyaryl Ether Sulfone Containing Isosorbide Units and End-Capped with L-Tyrosine

The same procedure as in Example 1 was followed except that 21.520 g (0.147 moles) isosorbide, 39.000 g (0.154 moles) difluorodiphenylsulfone (DFDPS), 1.112 g (0.00614 moles) L-tyrosine, 42.385 g (0.307 moles) K₂CO₃, and 130 g sulfolane were used. The contact angle measurement on a dense film of the polymer cast from NMP as described in Example 1, Tg, and the % water absorption are shown in Table 1.

### Example 3

### Synthesis of a Polyether Ketone Containing Isosorbide Units and End-Capped with L-Tyrosine

The same as in Example 1 was followed except that 23.790 g (0.163 moles) isosorbide, 37.000 g (0.170 moles) 4,4′-difluorobenzophenone (DFBP), 1.229 g (0.00678 moles) L-tyrosine, 35.142 g (0.254 moles) K₂CO₃, and 128 g sulfolane were used. The reaction time was seven hours. The contact angle measurement on a dense film of the polymer cast from NMP as described in Example 1, Tg, and the % water absorption are shown in Table 1.

### Comparative Example 1

### Synthesis of a Polyaryl Ether Sulfone Polymer Lacking Phenolic Aminoacid End-Capping

A commercial sample of Veradel® PES from Solvay Specialty Polymers prepared from DCDPS and bisphenol S without L-tyrosine was used to prepare a dense film cast from a 20% solution NMP as described in Example 1. The contact angle, Tg, and % water absorption measurements are given in Table 1.

### Comparative Example 2

### Synthesis of a Polyaryl Ether Sulfone Containing Isosorbide Units and Lacking Phenolic Aminoacid End-Capping

A polymer was prepared in the same way as Example 2 except that no L-tyrosine was added. A tough, creasable film was cast from a 20 wt % polymer solution in NMP as described in Example 1. The contact angle, Tg, and % water absorption measurements are given in Table 1.

### Comparative Example 3

### Synthesis of a Polyether Ketone Containing Isosorbide Units and Lacking Phenolic Aminoacid End-Capping

A polymer was prepared in the same way as Example 3 except that no tyrosine was added. A tough, creasable film was cast from a 20 wt % polymer solution in NMP as described in Example 1. The contact angle, Tg, and % water absorption measurements are given in Table 1.

TABLE 1
Static water contact angle (θ_{c}), % water absorption, and
Tg (DSC) measurements of polymer films cast from NMP
solutions and dried.

| | | Dihalo | Tyrosine/ | | | |
|---|---|---|---|---|---|---|
| | | com- | M2 | Contact | Water | |
| Exam- | | pound | Molar | Angle | absorption | T_{g} |
| ple | Diol (M1) | (M2) | ratio | (θ_{c}, °) | (wt %) | (° C.) |
| 1 | Bisphenol S | DCDPS | 0.04 | 77 | 4.0 | 218 |
| Comp 1 | Bisphenol S | DCDPS | 0 | 89 | 0.5 | 220 |
| 2 | Isosorbide | DFDPS | 0.04 | 59 | 3.7 | 226 |
| Comp 2 | Isosorbide | DFDPS | 0 | 73 | 2.5 | 230 |
| 3 | Isosorbide | DFBP | 0.04 | 58 | 3.4 | 187 |
| Comp 3 | Isosorbide | DFBP | 0 | 76 | 1.9 | 185 |

The polymers prepared with small amounts of L-tyrosine (examples 1-3) showed significantly lower θ_{c} water contact angles and increased water absorption compared to the corresponding polymers made without L-tyrosine (comparative examples 1-3). These results show a significant increase in polymer hydrophilicity when L-tyrosine was used, which is beneficial for membranes in water-based applications. In addition, the glass transition temperature (T_{g}) did not change significantly upon incorporating a small amount of tyrosine in the polymer, indicating that the thermal and mechanical properties of the membranes will be similar to the unmodified polymers.

### Example 4

### Preparation of Porous Flat Membranes

Porous films were prepared from NMP solutions of the polymers described in examples 1-3 by casting the solutions on glass plates using a BYK Gardner Automatic Film Applicator and, after two minutes, immersing the film and plate in a deionized water bath to give porous flat membranes. The membranes were separated from the glass and soaked in fresh water for several hours and the soaking was repeated two times with fresh water. SEM pictures of a cold-fractured edge of each membrane showed porous structures similar to commercial polyether sulfone membranes.

1-15. (canceled)

16. A polyaryl ether polymer (p-PAE) comprising recurring units of formula (Rₐ) below: 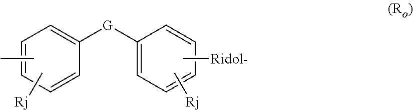
wherein:
G is a group of formula —C(O)— or a group of formula —SO₂—;
each of R, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j is zero or an integer from 1 to 4;
R_{diol} is a group of formula —O—R^{o}_{diol}-O—, wherein R^{o}_{diol} is independently selected from;
a) a straight or branched hydrocarbon chain containing from 2 to 20 carbon atoms, optionally substituted with one or more hydroxyl groups and optionally interrupted by one or more heteroatoms independently selected from N, O and S;
b) a C₃-C₁₂ cycloalkyl or a C₆-C₁₂-bicycloalkyl group, optionally containing one or more heteroatoms independently selected from N, O and S and optionally substituted with one or more C₁-C₄ straight or branched alkyl groups; and
c) an aryl group of formula —Ar¹-(T-Ar²)ₙ—, wherein:
Ar¹ and Ar², equal to or different from one another at each occurrence, are independently an aromatic mono or polynuclear group; and
T is selected from the group consisting of: a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula: 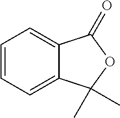
and n is 0 or an integer of 1 to 5;
said polyaryl ether polymer (p-PAE) comprising at least two chain ends, wherein at least one chain end is a unit of formula (Rₐₘᵢₙₒ) below: 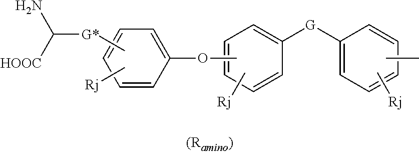
wherein G, R and j are as defined above, and G* is a straight or branched divalent alkylene group.

17. The polyaryl ether polymer (p-PAE) according to claim 16 comprising two chain ends, wherein each chain end is a unit of formula (Rₐₙᵢₙₒ₁) below: 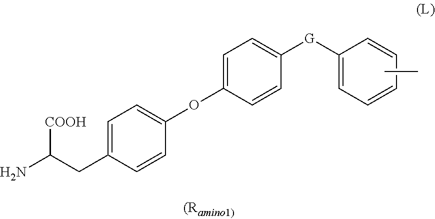
wherein G is as defined in claim 6.

18. The polyaryl ether polymer (p-PAE) according to claim 16 wherein at least one recurring unit (Rₐ) is a recurring unit in which R_{diol} is a group of formula —O—R^{o}_{diol}—O— selected from the group of formulae (I)-(III) below:

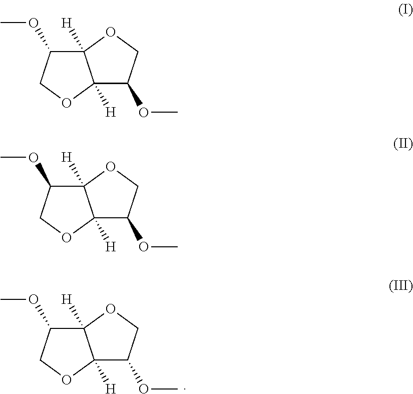

19. The polyaryl ether polymer (p-PAE) according to claim 16 wherein G is a —C(O)— group and wherein at least one of —O—R^{o}_{diol}-O— is a group of formula —O—Ar¹-(T-Ar²)ₙ—O— in which Ar¹, T, Ar² and n are as defined in claim 16.

20. The polyaryl ether polymer (p-PAE) according to claim 16 which is a polyaryl ether ketone (p-PAEK) further comprising at least one recurring unit (Ra^{o}) comprising an Ar—(CO)—Ar′ group, with Ar and Ar′, equal to or different from each other, being aromatic groups, said recurring unit)(Rₐ^{o}) being selected from the group of formulae (J-A) to (J-O) herein below: 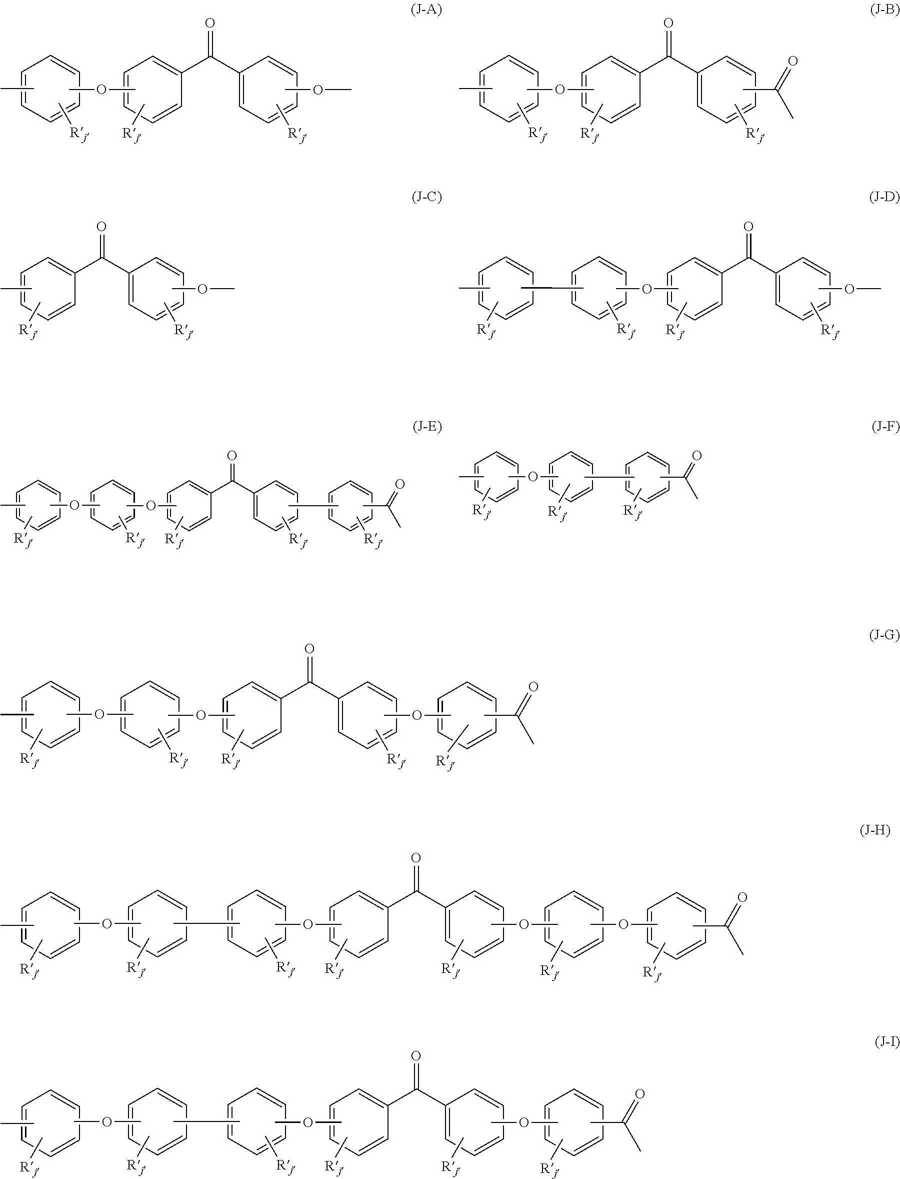 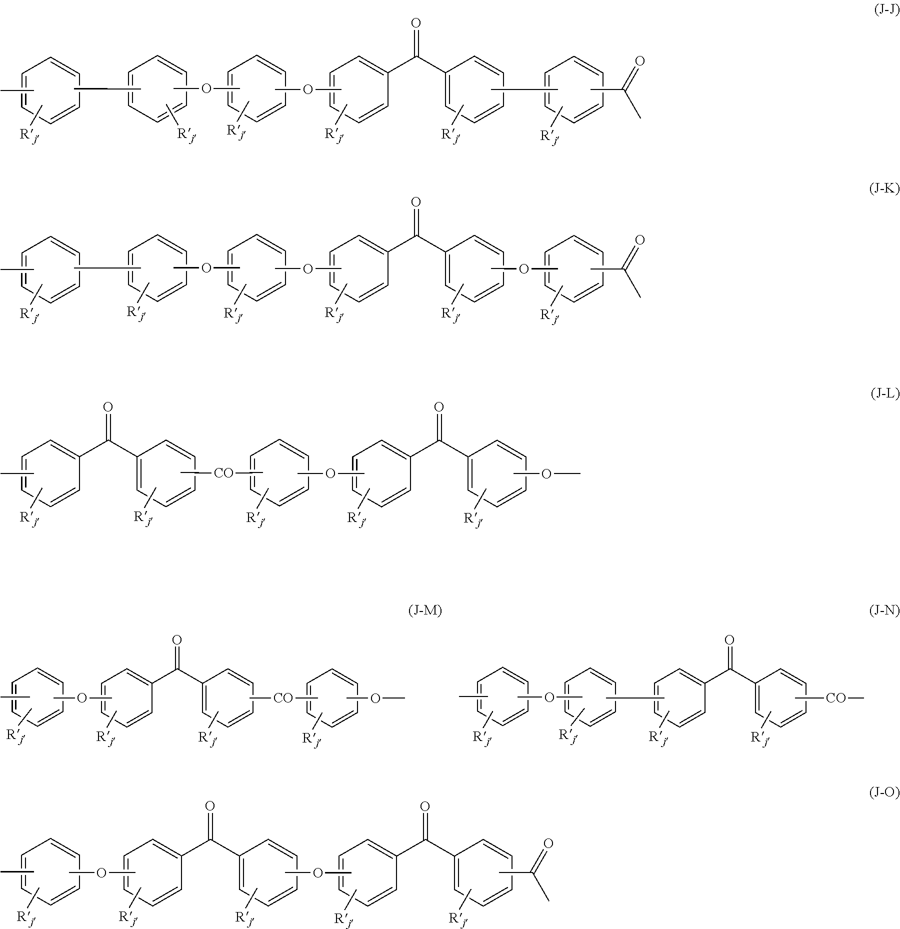
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium; and
j′ is zero or an integer from 0 to 4.

21. The polyaryl ether polymer (p-PAE) of claim 16 which is a polyaryl ether sulfone polymer (p-PES) further comprising at least one recurring units R*ₐ different from (Rₐ), said R*ₐ unit comprising an Ar—SO₂—Ar′ group, with Ar and Ar′, equal to or different from each other, being aromatic groups, said recurring units (R*ₐ) being selected from the following formulae: 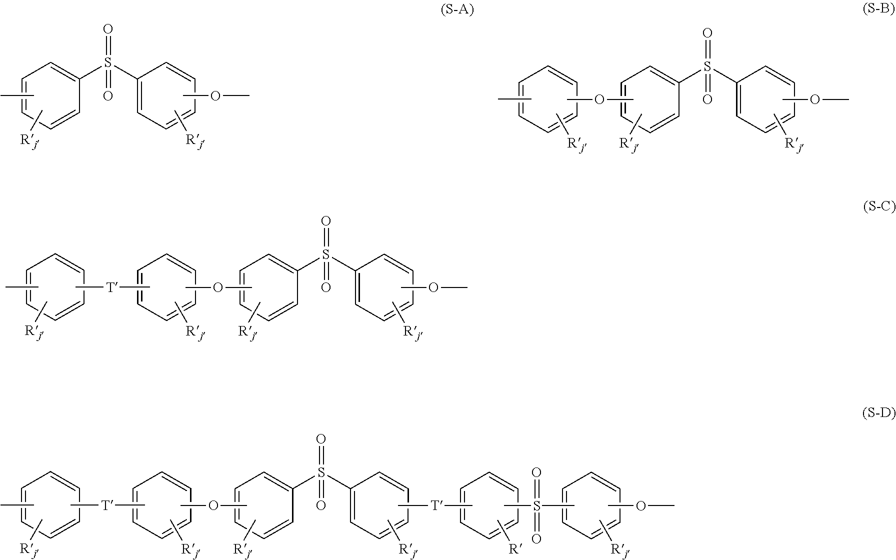
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium;
j′ is zero or is an integer from 0 to 4; and
T is defined in claim 16; and
T′ is a bond or a divalent group optionally comprising one or more than one heteroatom.

22. A process for manufacturing a polyaryl ether polymer (p-PAE) according to claim 16 which comprises reacting, in a solvent mixture comprising a polar aprotic solvent:
at least one dihalo compound, dihalo (AA): 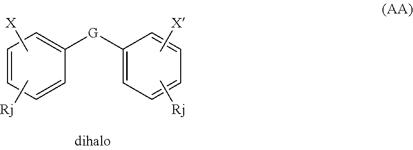
wherein G, R, and j are as defined in claim 16, and X and X′, equal to or different from one another, are halogen;
optionally, at least one dihalo compound (A′A′ₛ) different from the dihalo (AA), the dihalo compound (A′A′ₛ) comprising a Ar—SO₂—Ar′ group, wherein Ar and Ar′, equal to or different from one another, are aromatic groups;
at least one diol HO—R^{o}_{diol}-OH, wherein is defined in claim 16;
a phenolic aminoacid of formula: 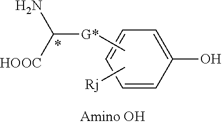
wherein G*, R and j are defined in claim 16; and
an alkali metal carbonate.

23. The process of claim 22 wherein the phenolic aminoacid is L-tyrosine.

24. The process of claim 22 wherein the HO—R^{o}diol-OH is selected from the group consisting of isosorbide, isomannide, and isoidide.

25. The process of claim 22 wherein HO—R^{o}diol-OH complies with formula (c1) below:
HO—Ar¹-(T′-Ar²)ₙ—OH formula (c1)
wherein:
n is zero or an integer of 1 to 5;
each of Ar¹ and Ar², equal to or different from each other and at each occurrence, is an aromatic moiety of the formula: 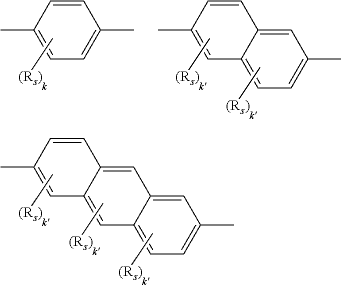
wherein:
each Rₛ is independently selected from the group consisting of halogen, alkyl, alkenyl, alkynyl, aryl, ether, thioether, carboxylic add, ester, amide, imide, alkali or alkaline earth metal sulfonate, alkyl sulfonate, alkali or alkaline earth metal phosphonate, alkyl phosphonate, amine, and quaternary ammonium;
k is zero or an integer of 1 to 4;
k′ is zero or an integer of 1 to 3; and
T′ is a bond or a divalent group optionally comprising one or more than one heteroatom.

26. A method for manufacturing membranes, films, sheets, and three dimensional moulded parts, said method comprising the use of a polyaryl ether polymer (p-PAE) as defined in claim 16.

27. A shaped article manufactured from the polyaryl ether polymer (p-PAE) of claim 16, said article being selected from the group consisting of melt processed films, solution processed films, melt processed monofilaments, melt processed fibers, solution processed monofilaments, hollow fibers, solid fibers, injection molded objects, and compression molded objects.

28. A shaped article manufactured from the polyaryl ether polymer (p-PAE) of claim 16, said article being selected from membranes for bioprocessing, membranes for medical filtrations, membranes for food and beverage processing, membranes for waste water treatment, and membranes for industrial process separations involving aqueous media.

29. A shaped article manufactured from the polyaryl ether polymer (p-PAE) of claim 16, wherein the shaped article is selected from films and sheets.

30. A shaped article manufactured from the polyaryl ether polymer (p-PAE) of claim 16, the article being selected from a three-dimensional moulded part.

31. The shaped article of claim 28, wherein the membrane for medical filtrations is a hemodialysis membrane.

32. The shaped article of claim 30, wherein the three-dimensional moulded part is a transparent or coloured part for medical or dental applications.
